(19) United States
(12) Patent Application Publication
(10) Pub. No.: US 2016/0088826 A1
(43) Pub. Date: Mar. 31, 2016

(54) FISHING ACCESSORY

(71) Applicant: Stephen Andrew LEIGH, Johannesburg (ZA)

(72) Inventor: Stephen Andrew Leigh, Johannesburg (ZA)

(21) Appl. No.: 14/889,640

(22) PCT Filed: May 6, 2014
(86) PCT No.: PCT/ZA2014/000025

§ 371 Date: Nov. 6, 2015

(30) Foreign Application Priority Data
May 6, 2013 (ZA) 2013/03259
Jun. 24, 2013 (ZA) 2013/04681

(51) Int. Cl. A01K 91/04

(52) U.S. Cl. CPC A01K 91/04

(57) ABSTRACT

According to the invention there is provided a fishing accessory (10) which includes a first retaining formation (12), a second retaining formation (14) and a linking formation (16, 18, 20) for interlinking the first and second retaining formations so that they are offset in different planes relative to each other.

### TECHNICAL FIELD OF THE INVENTION

This invention relates to accessories used in attaching fishhooks, lures and fishing line in various arrangements.

### BACKGROUND TO THE INVENTION

The inventor is aware of cross-lock and coast-lock snaps used in arrangements of fishhooks, fishing lines, sinkers, lures or similar fishing paraphernalia. Fishing snaps currently available in the art have all features arranged in a single plane. Traditionally, this problem may be overcome by making use of a swivel in order to allow free rotation of connected items attached to a line, lure or sinker.

A common practice is to attach treble hooks to trolling lures, through the use of a split ring. However, when a single hook is attached to a lure in a similar fashion it results in disorientation of the hook relative to the lure. In order to orient the hook an additional split ring may be inserted to correct the aspect of a single hook relative to the fishing lure. The use of multiple split rings may however lead to tangled lines and interfere with the swimming action of various lures.

It is an object of the invention to provide an alternative to existing fishhook and lure arrangements in order to overcome at least some of the difficulties identified above.

### SUMMARY OF INVENTION

According to the invention there is provided a fishing accessory which includes:
a first retaining formation;
a second retaining formation; and
a linking formation for interlinking the first and second retaining formations so that they are offset in different planes relative to each other.

The first and second retaining formations may be arranged substantially orthogonally relative to each other. The first and second retaining formation may be arranged at an acute angle relative to each other. The acute angle may be in the range of 30 to 60 degrees.

The first and or second retaining formation may be U-shaped and or C-shaped in form. The first and or second retaining formation may be in the form of a spiral. The first and or second retaining formation may be in the form of an elbow. The first and or second retaining formation may be in the form of a conventional eyelet and or a conventional split ring. The eyelet may have a fishhook contained therein. The retaining formations may be of any geometrical suitable shape and size for receiving and retaining an article therein. It is to be appreciated that the pair of retaining formations may be of similar configuration, or may even be of different configuration.

The linking formation may include a pair of elongate members which is configured and dimensioned to extend between and interconnects the opposing retaining formations, when in the operative closed condition.

The first and or second elongate member may include an access arrangement configured to be displaceable between an inoperative open condition for receiving an article, and an operative closed condition for retaining an article.

The linking formation may include a mounting means, with the mounting means slidably arranged thereon.

The mounting means may take the form of a cylindrical base with a plurality of strands arranged co-axially about the circumference of the base. An end of the base may be fitted with a cap so as to bend and provide for a separated splayed configuration of the strands, thereby defining a so called duster. The strands may be secured to the base by means of an adhesive or tie.

The linking formation may include a weight element, with the weight element slidably arranged thereon.

One application of the accessory is to attach fishhooks to fishing lures. The accessory is connected to a u-bolt of a lure by means of the first retaining formation retaining the u-bolt, with the second retaining formation retaining the fishhook. The first retaining formation will typically be in the form of a split ring with the second retaining formation in the form of an eyelet, with the fishhook retained therein. It is to be appreciated that the out of plane orientation of the retaining formations relative each other provides for a correct alignment or aspect of the hook relative to the lure.

In the above mentioned application, the first retaining formation can also be in the form of an eyelet, with a split ring retained therein, for connecting the accessory to the u-bolt of the lure. It is to be appreciated that in this embodiment wherein the first and second retaining formations are both in the form of a split ring, the retaining formations are interlinked by the linking formation so that they are in the same plane, relative to each other.

### BRIEF DESCRIPTION OF THE DRAWINGS

The invention will now be described by way of a non-limiting example with reference to the accompanying drawings.

In the drawings:

FIG. 1 shows a perspective view of first embodiment of a fishing accessory; in accordance with the invention;

FIG. 2 shows a perspective view of second embodiment of a fishing accessory, in accordance with the invention;

FIG. 3 shows a perspective view of a third embodiment of a fishing accessory in accordance with the invention;

FIG. 4 shows a partial perspective view of an alternative arrangement for a retaining formation for a fishing accessory, in accordance with the invention;

FIG. 5 shows a perspective view of a fourth embodiment of a fishing accessory, in accordance with the invention;

FIG. 6 shows a perspective view of the embodiment seen in FIG. 5 when in use and

FIG. 7 shows a perspective view of a fifth embodiment of a fishing accessory, in accordance with the invention.

### DETAILED DESCRIPTION OF THE INVENTION

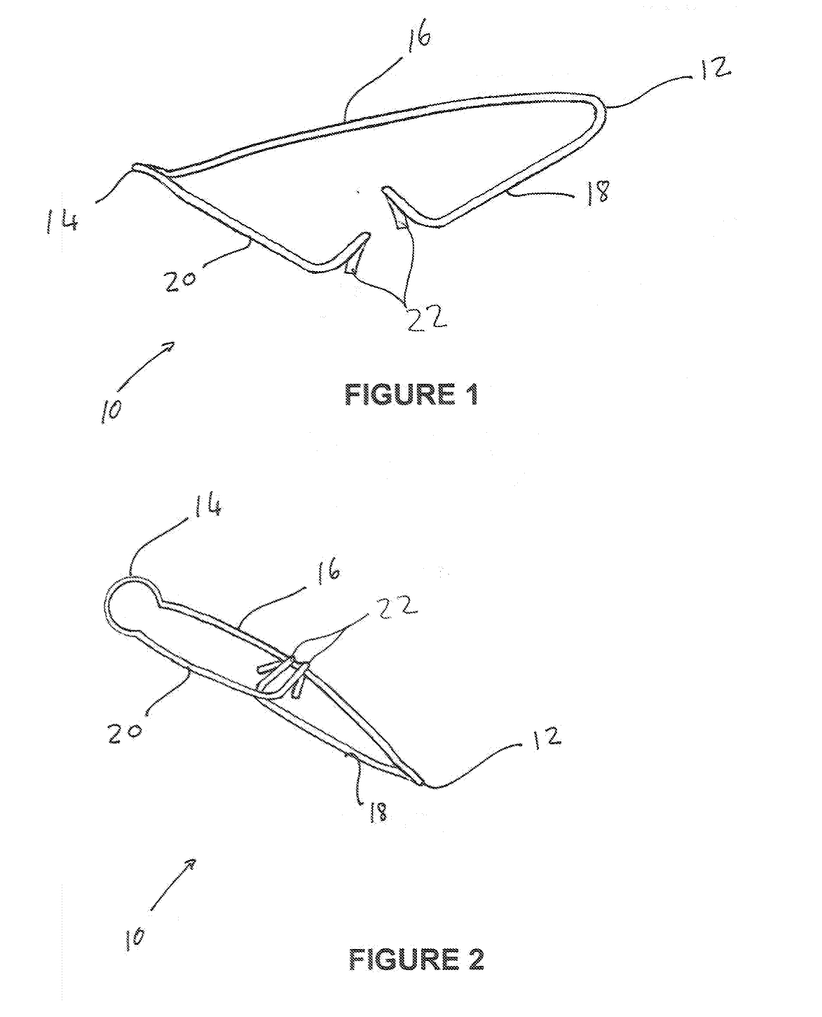

Referring to FIGS. 1 to 4, a fishing accessory 10 includes a first retaining formation 12, a second retaining formation 14 and a linking formation 16, 18 and 20 for interlinking the first and second retaining formations so that they are offset in different planes relative to each other. In a preferred embodiment of the invention the retaining formations 12, 14 are arranged substantially orthogonally relative each other.

The first and second retaining formations 12, 14 can be of different configurations, as more clearly shown in FIG. 1, where the first retaining formation 12 is elbow shaped and the second retaining formation 14 is semi-circular or c-shaped, in form.

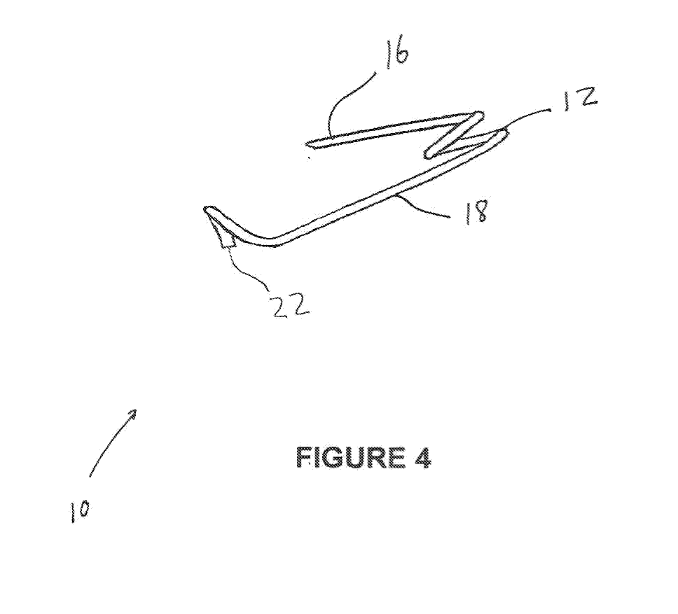

The first and second retaining formations 12, 14 can also be of similar shape, as shown in FIG. 2, where they are c-shaped in form, while in FIG. 3 they are u-shaped in form, or even in the form of a spiral as shown in FIG. 4.

The linking formation comprises an elongate member 16 which extends between and interconnects the retaining formations 12, 14 and a pair of further elongate members 18, 20 which extend between and interconnects the opposing retaining formations 12, 14. The pair of elongate members 18, 20 also includes an access arrangement 22 which is displaceable between an inoperative open condition for receiving an article, and an operative closed condition, for retaining an article.

The pair of elongate members 18, 20 will preferably include a biasing means for biasing the pair of elongate members towards an open condition so as retain an article therein.

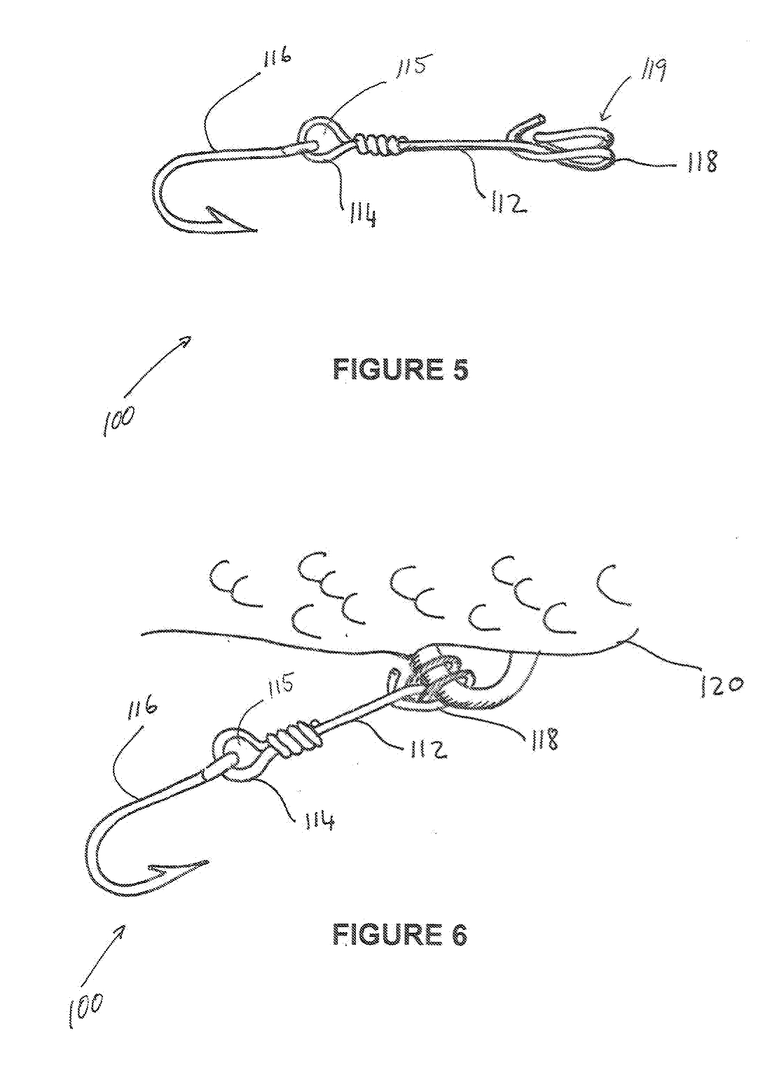

Referring now to FIGS. 5 and 6, one of the elongate members 114 of the pair of elongate members, can also be wound about the member 112 so as to define a retaining formation in the form of a so called eyelet 115. The eyelet 115 will typically be formed with a fishhook 116 contained therein. In this embodiment the other remaining elongate member 118 will be coiled so as to define a retaining formation in the form of a so called split ring 119 for releasably retaining an article, for example the u-bolt of lure 120 therein, as more clearly shown in FIG. 6.

It is to be appreciated that the eyelet 115 and split ring 119 configuration is interlinked by the linkage 112 offset in different planes relative to each other, with the angle of offset in the region of about 90 degrees.

It is further to be appreciated that due to the offset arrangement in a relative fixe position relative to each other, the aspect of a single hook relative to a lure corrected, resulting in a higher strike rate when fishing, without the need to incorporate additional split rings, as is the conventional manner of solving the disorientated aspect of a single hook relative to a lure.

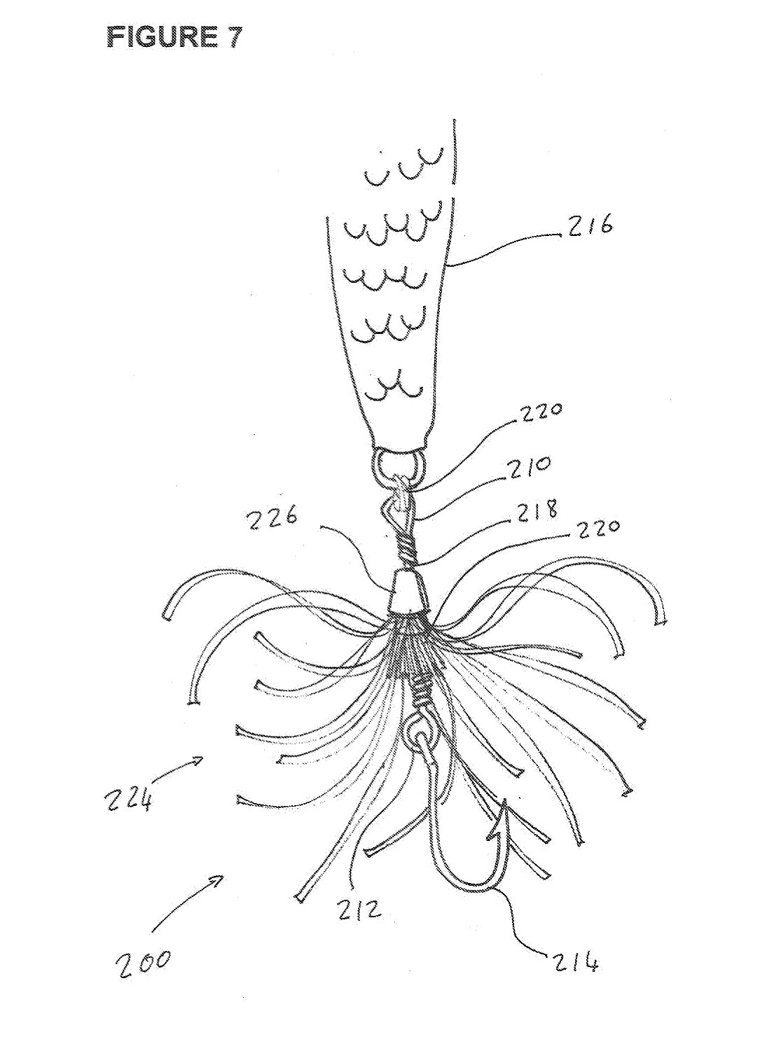

Turning now to FIG. 7, depicting a further embodiment of the fishing accessory 200, both of the retaining formations are in the form of eyelets 210, 212. In this embodiment, the elongate member 218 interlinks the eyelets 210, 212 in a similar plane of orientation, and not in an offset manner, as shown in FIGS. 1 to 6. The eyelet 210 is connected via a split ring 220 to the lure 216, to thereby correctly aligning the fishhook 214 to the lure 216.

The elongate member 218 includes a mounting means in the form of a cylindrical base 222 slidably arranged thereon. The cylindrical base 222 has a plurality of strands 224 arranged co-axially about the circumference of the base 222, with and end of the base fitted with a cap 226 so as to bend and provide for a separated splayed configuration of the strands 224, thereby defining a so called duster. The strands 224 can be secured to the base by means of an adhesive or tie or in any suitable manner.

The elongate member 218 can include a weight element (not shown), with the weight element slidably arranged thereon.

It shall be understood that the examples are provided for illustrating the invention further and to assist a person skilled in the art with understanding the invention and are not meant to be construed as unduly limiting the reasonable scope of the invention.

1. A fishing accessory which includes:
a first retaining formation;
a second retaining formation; and
a linking formation for interlinking the first and second retaining formations so that they are offset in different planes relative to each other.

2. A fishing accessory as claimed in claim 1 wherein the first and second retaining formations are arranged at an acute angle relative to each other.

3. A fishing accessory as claimed in claim 2 wherein the acute angle is in the range of 30 to 60 degrees.

4. A fishing accessory as claimed in claim 1 wherein the first and second retaining formations are arranged substantially orthogonally relative to each other.

5. A fishing accessory as claimed in claim 1 wherein the retaining formations are of any suitable geometric shape for retaining any articles to be attached thereto in a predetermined position relative to each other.

6. A fishing accessory as claimed in claim 1 wherein at least one of the retaining formations is in the form of a conventional eyelet.

7. A fishing accessory as claimed in claim 1 wherein at least one of the retaining formations is in the form of a conventional split ring.

8. A fishing accessory as claimed in claim 1 wherein at least one of the retaining formations is generally or substantially U-shaped.

9. A fishing accessory as claimed in claim 1 wherein at least one of the retaining formations is generally or substantially C-shaped.

10. A fishing accessory as claimed in claim 1 wherein at least one of the retaining formations is of substantial spiral form.

11. A fishing accessory as claimed in claim 1 wherein at least one of the retaining formations is in the form of an elbow.

12. A fishing accessory as claimed in claim 1 wherein the linking formation is in the form of an elongate member which is configured and dimensioned to extend between and interconnects the opposing retaining formations.

13. A fishing accessory as claimed in claim 1 wherein the linking formation includes a pair of elongate members which extend between opposing free ends of the retaining formations.

14. A fishing accessory as claimed in claim 13 wherein at least one of the elongate members has an access arrangement which is displaceable between an open condition for allowing access to the retaining formation, and a closed condition for inhibiting the removal of the articles from the retaining member.

15. A fishing accessory as claimed in claim 14 wherein the access arrangement includes a biasing means for biasing the access arrangement towards the closed condition.

16. A fishing accessory as claimed in claim 12 wherein the elongate member has a plurality of strands arranged in a splayed configuration co-axially about the circumference thereof.

17. A fishing accessory as claimed in claim 1 wherein the linking formation has a weight element slidably arranged thereon.

18. (canceled)

19. (canceled)

20. (canceled)
